(19) United States
(12) Patent Application Publication
(10) Pub. No.: US 2025/0292576 A1
(43) Pub. Date: Sep. 18, 2025

(54) VIDEO GENERATION

(71) Applicant: Beijing Zitiao Network Technology Co., Ltd., Beijing (CN)

(72) Inventors: Haoxiang Peng, Beijing (CN); Guodong Gao, Beijing (CN)

(21) Appl. No.: 18/983,363

(22) Filed: Dec. 17, 2024

(30) Foreign Application Priority Data
Mar. 12, 2024 (CN) 202410282187.2

(51) Int. Cl. G06V 20/40; G06V 10/60; G06V 10/74

(52) U.S. Cl. CPC G06V 20/49; G06V 10/60; G06V 10/761

(57) ABSTRACT

A method, an apparatus, a device, and a medium for generating a video are provided. In one method, a plurality of video frames in a first video are obtained. A plurality of evaluation indicators of the plurality of video frames in the first video are obtained, respectively. The plurality of video frames is divided into at least one group of consecutive video frames based on the plurality of evaluation indicators, respective evaluation indicators of respective video frames in the at least one group of consecutive video frames meeting a predetermined condition. For a first group of consecutive video frames in the at least one group of consecutive video frames, a first time period associated with the first group of consecutive video frames is determined. A second video is generated by using a first video segment in the first time period in the first video.

### CROSS-REFERENCE

The present application claims priority to Chinese Patent Application No. 202410282187.2, entitled “METHOD, APPARATUS, DEVICE AND MEDIUM FOR GENERATING VIDEO” filed on Mar. 12, 2024, the entirety of which is incorporated herein by reference.

### FIELD

Example implementations of the present disclosure generally relate to video processing, and in particular, to video generation.

### BACKGROUND

A variety of video editing tools have been developed that use a variety of video editing tools and generate expected video based on one or more original video materials. For example, a user may remove respective unsatisfied video segments from respective video materials, and keep only satisfactory video segments, and so on. However, the user has to view each video material one by one in order to find the video segment to be removed and/or the video segment that is expected to be kept, which results in lower video processing efficiency. At this point, it is expected to be able to generate new video in a simpler and efficient manner.

### SUMMARY

In a first aspect of the present disclosure, a method for generating a video is provided. In the method, a plurality of evaluation indicators of a plurality of video frames in a first video is obtained, respectively. The plurality of video frames is divided into at least one group of consecutive video frames based on the plurality of evaluation indicators, respective evaluation indicators of respective video frames in the at least one group of consecutive video frames meeting a predetermined condition. For a first group of consecutive video frames in the at least one group of consecutive video frames, a first time period associated with the first group of consecutive video frames is determined. A second video by using a first video segment in the first time period in the first video is generated.

In a second aspect of the present disclosure, an apparatus for generating a video is provided. The apparatus includes: an obtaining module, configured to obtain a plurality of evaluation indicators of a plurality of video frames in a first video, respectively; a dividing module, configured to divide the plurality of video frames into at least one group of consecutive video frames based on the plurality of evaluation indicators, respective evaluation indicators of respective video frames in the at least one group of consecutive video frames meeting a predetermined condition; a determining module, configured to determine, for a first group of consecutive video frames in the at least one group of consecutive video frames, a first time period associated with the first group of consecutive video frames; and a generation module, configured to generate a second video by using a first video segment in the first time period in the first video.

In a third aspect of the present disclosure, an electronic device is provided. The electronic device includes: at least one processing unit; and at least one memory coupled to the at least one processing unit and storing instructions for execution by the at least one processing unit, the instructions, when executed by the at least one processing unit, cause the electronic device to perform the method according to the first aspect of the present disclosure.

In a fourth aspect of the present disclosure, a computer-readable storage medium is provided. The computer-readable storage medium having a computer program stored thereon which, when executed by a processor, causes the processor to implement the method according to the first aspect of the present disclosure.

It should be understood that the content described in the summary section is not intended to limit key features or important features of implementations of the present disclosure, nor is it intended to limit the scope of the present disclosure. Other features of the present disclosure will become easily understood from the following description.

### BRIEF DESCRIPTION OF DRAWINGS

The above and other features, advantages, and aspects of the various implementations of the present disclosure will become more apparent from the following detailed description taken in conjunction with the accompanying drawings. In the drawings, the same or similar reference numbers refer to the same or similar elements, wherein:

FIG. 1 illustrates a block diagram of an application environment according to an example implementation of the present disclosure;

FIG. 2 illustrates a block diagram for generating a video according to some implementations of the present disclosure;

FIG. 3 illustrates a block diagram for determining a first video according to some implementations of the present disclosure;

FIG. 4 illustrates a block diagram of determining a plurality of video frames in a first video according to some implementations of the present disclosure;

FIG. 5 illustrates a block diagram for determining a score of a video frame according to some implementations of the present disclosure;

FIG. 6 illustrates a block diagram for determining a score related to a scene dimension according to some implementations of the present disclosure;

FIG. 7 illustrates a block diagram for adjusting a time period according to some implementations of the present disclosure;

FIG. 8 illustrates a block diagram for generating a second video based on video segments within each adjusted time period according to some implementations of the present disclosure;

FIG. 9 illustrates a flowchart of a method for generating a video according to some implementations of the present disclosure;

FIG. 10 illustrates a block diagram of an apparatus for generating a video according to some implementations of the present disclosure; and

FIG. 11 illustrates a block diagram of a device capable of implementing a plurality of implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “including” and similar terms should be understood as “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definitions may also be included below. As used herein, the term “model” may represent an association relationship between various data. For example, the association relationship may be obtained based on various technical solutions currently known and/or to be developed in the future.

It may be understood that the data (including but not limited to the data itself, the acquisition or use of the data) involved in the technical solution should follow the requirements of the corresponding laws and regulations and related regulations.

It can be understood that, before the technical solutions disclosed in the embodiments of the present disclosure are used, the types, the usage scope, the usage scenario of personal information related to the present disclosure, and the like should be notified to the user in an appropriate manner according to the relevant laws and regulations, and the authorization of the user should be obtained.

For example, in response to receiving an active request from a user, prompt information is sent to the user to explicitly prompt the user that the requested operation will need to acquire and use the personal information of the user. Therefore, the user can autonomously select whether to provide personal information to software or hardware executing the operation of the technical solution of the present disclosure according to the prompt information.

As an optional but non-limiting implementation, in response to receiving an active request of the user, a manner of sending prompt information to the user may be, for example, a pop-up window, and prompt information may be presented in a text in the pop-up window. In addition, the pop-up window may further carry a selection control for the user to select “agree” or “disagree” to provide personal information to the electronic device.

It may be understood that the above-mentioned processes of notifying the user and obtaining the authorization of the user are merely illustrative, and does not constitute a limitation on implementations of the present disclosure, and other manners of meeting related laws and regulations may also be applied to implementations of the present disclosure.

The term “in response to” as used herein means a state in which a corresponding event occurs, or a condition is satisfied. It will be appreciated that the execution time of a subsequent action performed in response to the event or condition is not necessarily strongly correlated with the time at which the event occurs, or the condition is satisfied. For example, in some cases, a subsequent action may be performed immediately when an event occurs, or the condition is satisfied; while in other cases, a subsequent action may be only performed after a period of time when an event occurs, or a condition is satisfied.

### Example Environment

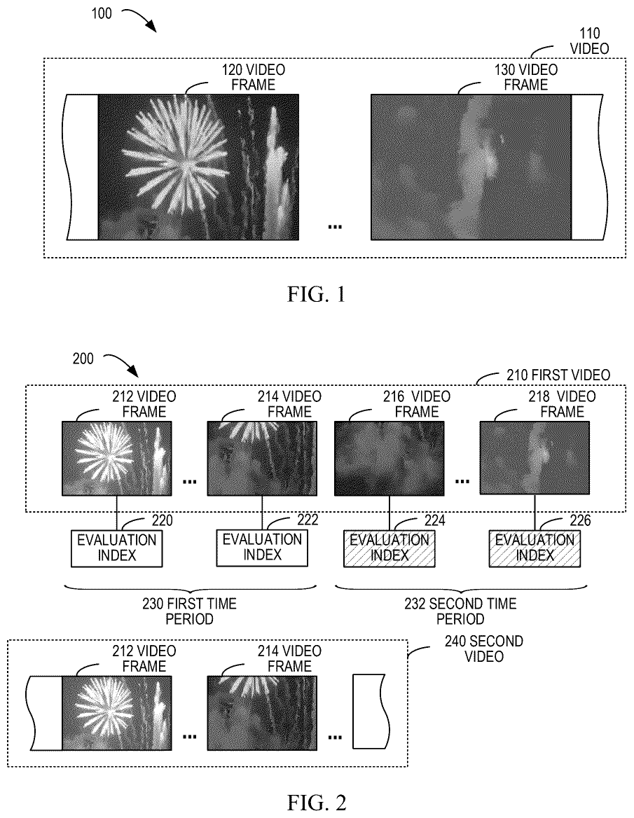

The user may use the video editing tool and use one or more video materials to generate the expected video. For example, the user may remove respective unsatisfied video segments from respective video material, and so on. FIG. 1 illustrates a block diagram 100 of an application environment according to an example implementation of the present disclosure. As shown in FIG. 1, the user may use the original video material (e.g., video 110) to generate a new video. For ease of description, a process of generating a video is described, as an example, by using only one video material to generate a new video.

It is assumed that video 110 includes a firework burning process, and at this time, each video frame in the video 110 may have different visual effects. For example, video frame 120 may relate to firework burning and include a gorgeous fire, however video frame 130 includes only a black sky and relates to an instant in which the firework is extinguished. In the process of editing the video, the user has to view respective video frames in respective video 110 one by one in order to find the video segments, and/or the video segment to be removed.

In order to achieve better visual effect, the user needs to repeatedly view the video and constantly adjust the boundaries of the video segments expected to be kept and the video segments expected to be removed with a manual editing tool, which results in lower video processing efficiency. Further, in the process of watching the local video segment, the user may lack the overall evaluation for the video, which causes the user to only determine the removing boundary according to the content change of the adjacent video frames before and after, and it is difficult to control the overall effect of the new video. At this point, it is expected to be able to generate a new video in a simpler and efficient manner.

### Summary of Generating Video

In order to at least partially solve the deficiencies in the prior art, according to an example implementation of the present disclosure, a method for generating a video is provided. Referring to FIG. 2, a summary according to an example implementation of the present disclosure is described, and FIG. 2 illustrates a block diagram 200 for generating a video according to some implementations of the present disclosure. As shown in FIG. 2, in the process of generating the second video 230 based on the first video 210, a plurality of video frames (e.g., video frames 212, . . . , 214, 216, . . . , and 218) in the first video 210 may be obtained. A plurality of evaluation indicators (also referred to as evaluation indicators, e.g., evaluation indicators 220, . . . , 222, 224, . . . , and 226) of the plurality of video frames may be determined, respectively. According to an example implementation of the present disclosure, the evaluation indicator may be determined in various manners, for example, the evaluation indicator may be determined based on image analysis and processing, for example, the evaluation indicator may be determined by using a pre-trained machine learning model.

Then, based on the plurality of evaluation indicators, the plurality of video frames may be divided into at least one group of consecutive video frames, and respective evaluation indicators of respective video frames in the at least one group of consecutive video frames meets a predetermined condition. For a first group of consecutive video frames (e.g., video frames 212, . . . , 214) of the plurality of video frames, respective evaluation indicators of respective video frames in the first group of consecutive video frames meet a predetermined condition (e.g., the evaluation indicator is higher than a predetermined threshold). For another example, for a second group of consecutive video frames (for example, video frames 216, . . . , 218) in the plurality of video frames, respective evaluation indicators of respective video frames in the second group of consecutive video frames are lower than a predetermined threshold.

A first time period 230 associated with the first group of consecutive video frames 212, . . . , 214 may be determined. In other words, the first video 210 may be divided according to a plurality of time points based on whether respective evaluation indicators of respective video frames meet a predetermined condition. For example, the evaluation indicators 224, . . . , and 226 of the video frames 216, . . . , and 218 do not meet the predetermined condition, and thus the second time period 232 may be determined. Further, the second video 240 may be generated by using the first video segment in the first time period 230 in the first video 210. In this case, the generated second video 240 does not include the video frame in the first video 210 that does not meet the predetermined condition, so that the video segment that does not meet the expected condition may be automatically removed.

With the example implementations of the present disclosure, respective evaluation indicators of respective video frames may evaluate respective qualities of respective video frames in a unified manner. The user may specify an expected filtering condition, and only video frames whose evaluation indicators meet the filtering condition are kept in the generated second video 240. In this way, a new video may be generated in a simpler and efficient manner.

### Detailed Procedure for Generating Video

Having described a summary according to one example implementation of the present disclosure, in the following, more details with regard to generating a video will be provided. According to an example implementation of the present disclosure, the evaluation indicator may be represented in a plurality of manners. Here, the evaluation indicator may indicate whether the quality of a video frame is suitable for generating the final video, and at this time, the evaluation indicator may represent the quality evaluation indicator. For example, a predetermined range of values may be specified, e.g., [0, 1] or [0, 100], etc., and an evaluation indicator is represented by using scores that fall within the range. For another example, “high”, “medium”, “low” and the like may be used to represent the evaluation indicator in a discrete manner. For ease of description, more details of generating the video will be described below by using the score as an example.

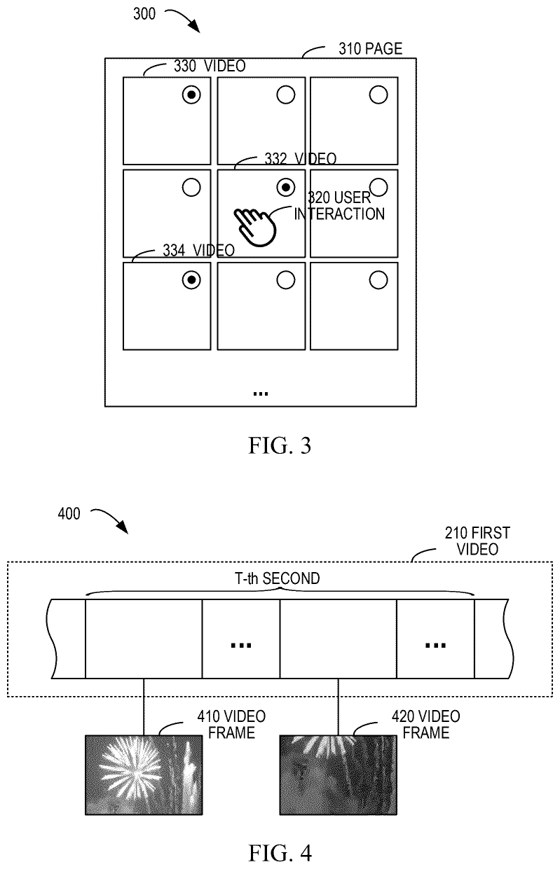

According to an example implementation of the present disclosure, the first video may be obtained in a plurality of manners, and more details are described with reference to FIG. 3. FIG. 3 shows a block diagram 300 for obtaining a first video according to some implementations of the present disclosure. As shown in FIG. 3, a page 310 may be provided to a user, for example, a user may select one or more videos used as original video materials from an album and/or other folders. The user may select a single video, alternatively and/or additionally, the user may select a plurality of videos as the original video material.

Assuming that the user only selects a single video, the single video may be directly used as the first video 210. Assuming that the user selects a plurality of videos (for example, videos 330, 332, and 334), videos 330, 332, and 334 may be connected in a predetermined time order (for example, the user selects a time order for each video), thereby generating a longer first video. With example implementations of the present disclosure, a user is allowed to determine a first video to be processed in a more flexible manner. Alternatively and/or additionally, the user may perform an editing on the first video For example, the user may add content such as a text, a sticker, and/or a background music to the video, and further invoke the process described with reference to FIG. 2 to determine a score of each video frame in the first video, thereby removing the video segment whose score does not meet the predetermined filtering condition.

According to an example implementation of the present disclosure, the plurality of video frames may be obtained in a plurality of manners. For example, all video frames in the first video may be obtained. In this way, the score of each video frame may be determined, thereby improving the accuracy of video processing. Alternatively and/or additionally, to reduce the amount of computation in the subsequent processing, the plurality of video frames may be determined from the first plurality of video frames (i.e., all video frames) in the first video at a predetermined interval, where the number of the plurality of video frames may be less than the number of the first plurality of video frames.

Referring to FIG. 4, a process of determining a plurality of video frames is described, and FIG. 4 illustrates a block diagram 400 of determining a plurality of video frames in a first video based on a down-sampling process according to some implementations of the present disclosure. As shown in FIG. 4, it is assumed that the video at T-th second includes N (N is an integer) video frames, and a part of video frames may be obtained from the first video in a down-sampling manner, such as 2 frames per second (or another predetermined interval). In other words, only video frames at the first frame (e.g., video frame 410) and the second frame (e.g., video frame 420) are obtained per second, and video frames at other time points are ignored.

In this way, during subsequent processing, the score is determined only for a part of the sampled video frames, so that the amount of computation may be reduced without affecting the visual effect as much as possible. Since only a small amount of computation is involved in this case, an example implementation according to the present disclosure may be performed at a mobile computing device (e.g., a mobile terminal) with limited performance.

According to one example implementation of the present disclosure, a corresponding score may be determined for each video frame of the plurality of video frames. Specifically, with respect to the target video frame in the plurality of video frames, a score corresponding to the at least one score dimension may be determined, and the at least one score dimension includes at least any of: an image dimension of the target video frame, or a scene dimension of the target video frame. Further, a target quality score for the target video frame among the plurality of scores may be determined based on a score corresponding to the at least one score dimension. According to example implementations of the present disclosure, the quality of each video frame may be comprehensively evaluated based on different dimensions, and then the video segment expected to be kept is selected from the first video in a more accurate manner. It should be understood that the target video frame herein may be each video frame in a plurality of video frames, and each video frame may be processed in a similar manner, to obtain a quality score of each video frame.

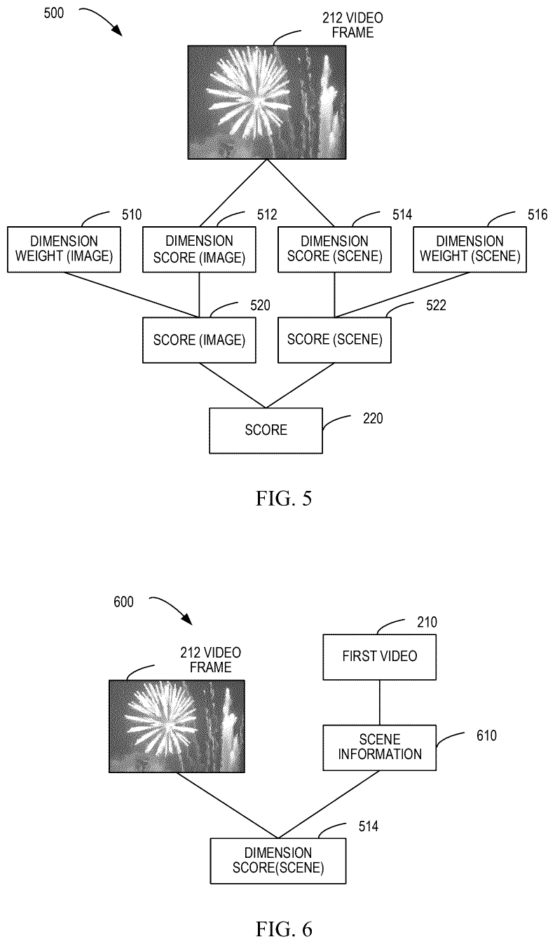

Further details are described with reference to FIG. 5, which illustrates a block diagram 500 for determining a score for a video frame according to some implementations of the present disclosure. As shown in FIG. 5, a plurality of score dimensions, such as an image-related dimension score 512 and a scene-related dimension score 514, may be pre-specified. Further, the respective weights of respective score dimensions may be determined. For example, a dimension weight 510 may correspond to a dimension score 512, and a dimension weight 516 may correspond to a dimension score 514. According to an example implementation of the present disclosure, each weight may be determined based on a plurality of manners, for example, a user may specify a weight. It is assumed that the user considers that the image may affect the final video effect more, a higher weight may be given to the image dimension. It is assumed that the user considers that the scene may affect the final video effect more, and a higher weight may be given to the scene dimension. In this way, the scoring manner may be set according to the user preference, so that the generated video is more consistent with the expectation of the user.

Further, the final score 220 of the video frame 212 may be determined based on a weighted summation. For example, the score 520 may be determined based on the product of the dimension weight 510 and the dimension score, and the score 522 may be determined based on the product of the dimension weight 516 and the dimension score 514, and then the score 220 may be determined based on the sum of the scores 520 and 522. With example implementations of the present disclosure, the score 220 may reflect the matching degree between the video frame 212 and the user's expectation from many aspects, thereby determining the video segment expected to be kept in a more accurate and efficient manner. With example implementations of the present disclosure, the quality of each video frame may be evaluated in a quantized and unified manner from different aspects, such as from an image aspect and a scene aspect, respectively, to automatically determine video segments that are expected to be kept and/or deleted.

According to an example implementation of the present disclosure, an evaluation indicator for the image dimension indicates at least any of: a clarity, a contrast, or brightness of an image of the target video frame. Specifically, the target video frame with a higher clarity may have a higher score, a target video frame with a relatively soft contrast (for example, meeting a predetermined range) may have a higher score, and a target video frame with a moderate brightness may have a higher score, and so on. The above scores may be determined based on various image processing processes and/or machine learning models currently known and/or to be developed in the future. In this way, video frames with better visual effects may be determined based on multiple aesthetic needs.

According to an example implementation of the present disclosure, an evaluation indicator for the scene dimension indicates a matching degree between a target scene of the target video frame and scene information. It should be understood that the scene information may be obtained by analyzing the first video as a whole, and FIG. 6 describes more details. FIG. 6 illustrates a block diagram 600 for determining a score related to a scene dimension according to some implementations of the present disclosure. As shown in FIG. 6, the scene information 610 of the first video 210 may be determined based on various image processing processes and/or machine learning models currently known and/or to be developed in the future. Further, the matching degree between the scene in the video frame 212 and the scene information 610 may be determined, and then the dimension score 514 of the video frame 212 may be determined.

Specifically, it is assumed that the scene information 610 indicates that the first video 210 generally relates to “fireworks”, and that the content of the video frame 212 also relates to “fireworks”. At this time, it can be determined that the matching degree between the scene in the video frame 212 and the scene information 610 is high, and thus the dimension score 514 may be set to a higher value. For another example, for the video frame 218, the content of the video frame relates to a black night sky after the firework is extinguished. At this time, it may be determined that the matching degree between the scene in the video frame 218 and the scene information 610 is relatively low, and thus the dimension score may be set to a lower value. With example implementations of the present disclosure, video frames that do not conform to the scene information may be determined in a simpler and more efficient manner, thereby finding the video segments to be removed.

According to an example implementation of the present disclosure, in a process of determining a target quality score for a target video frame, a scene type of the first video may be determined, and a score weight for the at least one score dimension may be determined based on the scene type. It should be understood that this scenario type may include a static scenario and a dynamic scenario. Further, the target quality score may be determined based on the at least one score weight and the at least one score dimension. Here, different types of scenarios may correspond to different evaluation criteria.

For example, when watching a video including a static scene, the user may be more concerned about whether the image in the video is clear, whether the color is soft, or the like. For another example, when viewing a video including a dynamic scene, the user may be more concerned about whether a shot of the video is jittery, whether an object in the video is shielded, and the like. According to example implementations of the present disclosure, the respective weights may be determined based on respective sensitivity degrees of the user in respective dimensions, so as to evaluate the quality of each video frame in a more accurate and effective manner.

According to an example implementation of the present disclosure, determining the score weight includes at least any of: in response to determining that the scene type indicates a static scene, increasing an score weight for the image dimension, and decreasing a score weight for the scene dimension; and in response to determining that the scene type indicates a dynamic scene, increasing a score weight for the scene dimension, and decreasing a score weight for the image dimension.

Generally, when a video relates to a static scene, image quality (e.g., such as clarity, contrast, brightness, etc. of the image) will more affect the visual experience of the user. In this case, a higher weight may be given to the image dimension, and the weight of the scene dimension may be appropriately decreased. For another example, when the video relates to a dynamic scene, jitter in the shooting process, and/or a passerby mistakenly entering the imaging range of the lens may affect the visual experience of the user. At this time, a higher weight may be given to the scene dimension, and the weight of the image dimension may be appropriately decreased. In this way, the quality of each video frame may be measured in a more accurate manner, thereby generating a video with a higher visual effect.

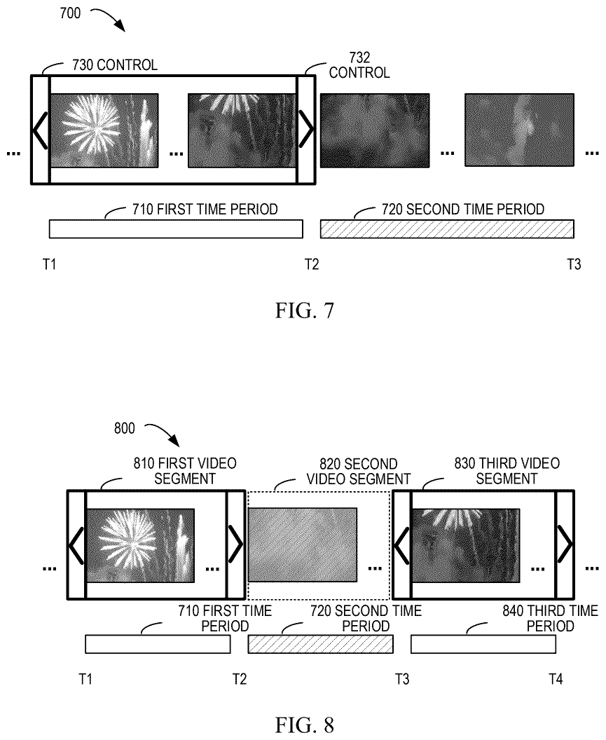

According to an example implementation of the present disclosure, for a second group of consecutive video frames in the plurality of video frames, a second time period associated with the second group of consecutive video frames is determined in response to determining that respective evaluation indicators of respective video frames in the second group of consecutive video frames do not meet the predetermined condition. The first time period is indicated by using a first format and the second time period is indicated by using a second format. More details are described with reference to FIG. 7, which illustrates a block diagram 700 for adjusting a time period according to some implementations of the present disclosure. As shown in FIG. 7, different formats may be used to represent the first time period 710 recommended to be kept and the second time period 720 recommended to be deleted. With example implementations of the present disclosure, video segments to be kept and video segments to be removed may be indicated in different formats. In this way, a user may be supported to distinguish different types of video segments in a more explicit manner, thereby determining whether each video segment needs to be adjusted.

According to one example implementation of the present disclosure, an adjustment control for adjusting the first time period may be presented. With continued reference to FIG. 7, controls 730 and 732 may be presented on two sides of each video frame in the first time period 710, respectively, so that the user adjusts the range of the first time period. In response to receiving the interactive operation for the adjustment control, the first time period is adjusted based on the interaction operation.

Specifically, the user may drag the control 730 to the left, and at this time, the start time point of the first time period 710 may move forward (for example, move to the time point T1′ before the time point T1). For another example, the user may drag the control 732 to the right, and at this time, the end time point of the first time period 710 may move backward (for example, move to the time point T2′ after the time point T2). It should be understood that, when the user uses control 732 to adjust the first time period 710, the start time point of the second time period 720 also accordingly moves to the time point T2′. At this time, the end time point of the first time period 710 is overlapped with the start time point of the second time period 720. Alternatively and/or additionally, the adjustment controls may be presented on both sides of the second time period so as to adjust the second time period. With example implementations of the present disclosure, the user may be enabled to manually adjust each time period to control process of video generation in a more precise manner.

According to an example implementation of the present disclosure, the second video may be generated by using the adjusted video segment in the first time period. In this way, in response to automatically determining video segments recommended to be kept and recommended to be removed, a higher editing precision may be provided to the user, thereby generating a more expected video.

The process of generating the second video is described above only taking that the first video includes two video segments as an example. According to an example implementation of the present disclosure, based on the score of each video frame, the first video may be divided into more video segments. Specifically, for a third group of consecutive video frames in the plurality of video frames, a third time period associated with the third group of consecutive video frames is determined in response to determining that respective evaluation indicators of respective video frames in the third group of consecutive video frames meet the predetermined condition. Further, the second video is generated by using the first video segment and a third video segment in the third time period.

More details are described with reference to FIG. 8, which illustrates a block diagram 800 for generating a second video based on video segments within each adjusted time period according to some implementations of the present disclosure. The first time period 710, the second time period 720, and the third time period 840 may be determined according to the methods described above. As shown in FIG. 8, respective video segments within respective time periods may be presented in different formats. For example, the first video segment 810 and the third video segment 830 that are recommended to be kept may be presented in a normal mode, the second video segment 820 recommended to be deleted may be presented in grayscale mode, and so on. The user may finely adjust each time period in the manner described above, after confirming each time period, the user may use the first video segment 810 and the third video segment 830 to generate a new video.

It should be understood that, although only some time periods are determined based on some video frames in the down-sampling process described above, the video segments in a certain time period may include all video frames in the time period. Specifically, the first video segment 810 includes all video frames within the first time period 710, the second video segment 820 includes all video frames within the second time period 720, and the third video segment 830 includes all video frames within the third time period 840.

With example implementations of the present disclosure, in the process of generating the second video, the video segment that does not meet the predetermined condition may be removed from the first video, and the second video that is more consistent with the user's expectation is generated by using the plurality of video segments that meet the predetermined condition in the first video. In the example of FIG. 8, the generated second video includes only the first video segment 810 and the third video segment 830, and does not include the second video segment 820.

According to an example implementation of the present disclosure, the second video may be generated by using the first video segment and the third video segment in a plurality of manners. For example, the first video segment and the third video segment may be directly spliced, thereby generating the second video. Alternatively and/or additionally, a transition video segment between the first video segment and the third video segment may be generated based on the first video segment and the third video segment. Further, the second video may be generated based on the first video segment, the third video segment, and the transition video segment. Specifically, the transition video segment may be generated based on special effects such as fade-in and fade-out. In this way, the problem of too stiff image conversion caused by simple splicing of different videos in the generated video can be avoided.

With the example implementations of the present disclosure, respective scores of respective video frames may evaluate respective qualities of respective video frames in a unified manner. The user may specify an expected filtering condition, and only video segments that meet the filtering condition are kept in the generated second video 240. In this way, low-quality segments and/or video frames may be automatically identified, for example, a blurriness segment, a meaningless segment, a segment with a lower image score, a segment with a larger deviation from the overall video, a segment that a passerby mistakenly enters the imaging range of the lens, and the like. Further, the segments recommended to be kept and/or segments recommended to be kept may be presented to the user, and the video to be processed may be analyzed in a more accurate manner, to provide a more targeted video editing suggestion, thereby avoiding the risk of deleting high-quality segments that may occur in the manual editing process of the user.

### Example Processes

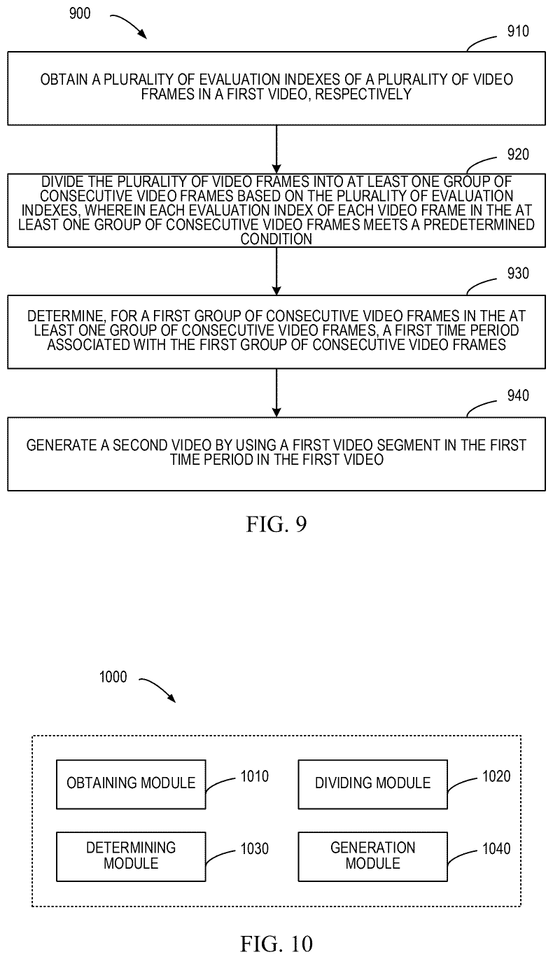

FIG. 9 shows a flowchart of a method 900 for generating a video according to some implementations of the present disclosure. At block 910, a plurality of evaluation indicators of a plurality of video frames in a first video are obtained, respectively. At block 920, based on the plurality of evaluation indicators, the plurality of video frames is divided into at least one group of consecutive video frames based on the plurality of evaluation indicators, respective evaluation indicators of respective video frames in the at least one group of consecutive video frames meeting a predetermined condition. At block 930, for a first group of consecutive video frames in the at least one group of consecutive video frames, a first time period associated with the first group of consecutive video frames is determined. At block 940, a second video is generated by using the first video segment in the first time period in the first video.

According to an example implementation of the present disclosure, the plurality of video frames is obtained by: determining the plurality of video frames from a first plurality of video frames in the first video according to a predetermined interval, a number of the plurality of video frames being less than or equal to a number of the first plurality of video frames.

According to an example implementation of the present disclosure, the first video includes at least any of: a single video; or a plurality of videos connected in a predetermined time order.

According to an example implementation of the present disclosure, obtaining the plurality of evaluation indicators respectively includes: with respect to a target video frame in the plurality of video frames, determining an evaluation indicator corresponding to at least one evaluation indicator dimension, the at least one evaluation indicator dimension including at least any of: an image dimension of the target video frame, or a scene dimension of the target video frame; and determining a target evaluation indicator for the target video frame among the plurality of evaluation indicators based on the evaluation indicator corresponding to the at least one evaluation indicator dimension.

According to an example implementation of the present disclosure, an evaluation indicator for the image dimension indicates at least any of: a clarity, a contrast, or brightness of an image of the target video frame; and an evaluation indicator for the scene dimension indicates a matching degree between a target scene of the target video frame and scene information.

According to an example implementation of the present disclosure, determining the target evaluation indicator for the target video frame includes: determining a scene type of the first video; determining at least one evaluation indicator weight for the at least one evaluation indicator dimension based on the scene type; and determining the target evaluation indicator based on the at least one evaluation indicator weight and the at least one evaluation indicator dimension.

According to an example implementation of the present disclosure, determining at least one evaluation indicator weight includes at least any of: in response to determining that the scene type indicates a static scene, increasing an evaluation indicator weight for the image dimension, and decreasing an evaluation indicator weight for the scene dimension; or in response to determining that the scene type indicates a dynamic scene, increasing an evaluation indicator weight for the scene dimension, and decreasing an evaluation indicator weight for the image dimension.

According to an example implementation of the present disclosure, the method further includes: determining, for a second group of consecutive video frames in the plurality of video frames, a second time period associated with the second group of consecutive video frames in response to determining that respective evaluation indicators of respective video frames in the second group of consecutive video frames do not meet the predetermined condition; and indicating the first time period by using a first format and indicating the second time period by using a second format.

According to an example implementation of the present disclosure, the method further includes: presenting an adjustment control for adjusting the first time period; and in response to receiving an interaction operation for the adjustment control, adjusting the first time period based on the interaction operation.

According to an example implementation of the present disclosure, the method further includes: generating the second video by using a video segment within the adjusted first time period.

According to an example implementation of the present disclosure, generating the second video further includes: determining, for a third group of consecutive video frames in the plurality of video frames, a third time period associated with the third group of consecutive video frames in response to determining that respective evaluation indicators of respective video frames in the third group of consecutive video frames meet the predetermined condition; and generating the second video by using the first video segment and a third video segment in the third time period.

According to an example implementation of the present disclosure, generating the second video by using the first video segment and the third video segment includes: generating a transition video segment between the first video segment and the third video segment based on the first video segment and the third video segment; and generating the second video based on the first video segment, the third video segment, and the transition video segment.

### Example Apparatus and Device

FIG. 10 illustrates a block diagram of an apparatus 1000 for generating a video according to some implementations of the present disclosure. The apparatus 1000 includes: an obtaining module 1010, configured to obtain a plurality of evaluation indicators of a plurality of video frames in a first video, respectively; a dividing module 1020, configured to divide the plurality of video frames into at least one group of consecutive video frames based on the plurality of evaluation indicators, respective evaluation indicators of respective video frames in the at least one group of consecutive video frames meeting a predetermined condition; a determining module 1030, configured to determine, for a first group of consecutive video frames in the at least one group of consecutive video frames, a first time period associated with the first group of consecutive video frames; and a generation module 1040, configured to generate a second video by using a first video segment in the first time period in the first video.

According to an example implementation of the present disclosure, the obtaining module includes: a sampling module, configured to determine the plurality of video frames from a first plurality of video frames in the first video according to a predetermined interval, a number of the plurality of video frames being less than or equal to a number of the first plurality of video frames.

According to an example implementation of the present disclosure, the first video includes at least any of: a single video; or a plurality of videos connected in a predetermined time order.

According to an example implementation of the present disclosure, the obtaining module includes: an evaluation indicator determining module, configured to determine an evaluation indicator corresponding to at least one evaluation indicator dimension, the at least one evaluation indicator dimension including at least any of: an image dimension of the target video frame, or a scene dimension of the target video frame; and a target evaluation indicator determining module, configured to determine a target evaluation indicator for the target video frame among the plurality of evaluation indicators based on the evaluation indicator corresponding to the at least one evaluation indicator dimension.

According to an example implementation of the present disclosure, an evaluation indicator for the image dimension indicates at least any of: a clarity, a contrast, or brightness of an image of the target video frame; and an evaluation indicator for the scene dimension indicates a matching degree between a target scene of the target video frame and scene information.

According to an example implementation of the present disclosure, the target evaluation indicator determination module includes: a scene type determination module configured to determine a scene type of the first video; a weight determination module configured to determine at least one evaluation indicator weight for the at least one evaluation indicator dimension based on the scene type; and a weighting module configured to determine the target evaluation indicator based on the at least one evaluation indicator weight and the at least one evaluation indicator dimension.

According to an example implementation of the present disclosure, the weight determining module includes: a first setting module, configured to, in response to determining that the scene type indicates a static scene, increase an evaluation indicator weight for the image dimension, and decrease an evaluation indicator weight for the scene dimension; and a second setting module, configured to, in response to determining that the scene type indicates a dynamic scene, increase an evaluation indicator weight for the scene dimension, and decrease an evaluation indicator weight for the image dimension.

According to an example implementation of the present disclosure, the apparatus further includes: a filtering module configured to determine, for a second group of consecutive video frames in the plurality of video frames, a second time period associated with the second group of consecutive video frames in response to determining that respective evaluation indicators of respective video frames in the second group of consecutive video frames do not meet the predetermined condition; and an indication module configured to indicate the first time period by using a first format and indicating the second time period by using a second format.

According to an example implementation of the present disclosure, the apparatus further includes: a presentation module configured to present an adjustment control for adjusting the first time period; and an adjustment module configured to, in response to receiving an interaction operation for the adjustment control, adjust the first time period based on the interaction operation.

According to an example implementation of the present disclosure, the generating module is further configured to: generate the second video by using a video segment within the adjusted first time period.

According to an example implementation of the present disclosure, the second determining module is further configured to: determine, for a third group of consecutive video frames in the plurality of video frames, a third time period associated with the third group of consecutive video frames in response to determining that respective evaluation indicators of respective video frames in the third group of consecutive video frames meet the predetermined condition; and the generation module includes: a combination module, configured to generate the second video by using the first video segment and a third video segment in the third time period.

According to an example implementation of the present disclosure, the combination module includes: a transition segment generation module configured to generate a transition video segment between the first video segment and the third video segment based on the first video segment and the third video segment; and a connection module configured to generate the second video based on the first video segment, the third video segment, and the transition video segment.

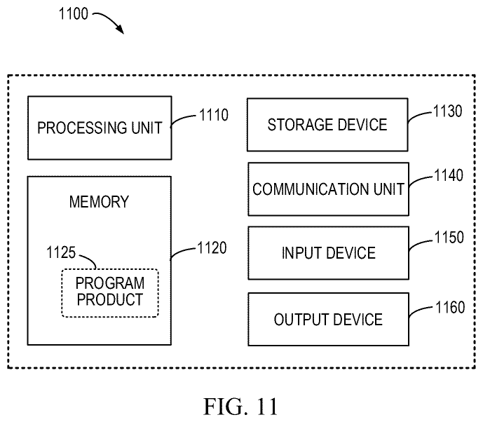

FIG. 11 illustrates a block diagram of a device 1100 capable of implementing a plurality of implementations of the present disclosure. It should be understood that the computing device 1100 shown in FIG. 11 is merely illustrative and should not constitute any limitation on the functionality and scope of the implementations described herein. The computing device 1100 shown in FIG. 11 may be configured to implement the method described above.

As shown in FIG. 11, the computing device 1100 is in the form of a general-purpose computing device. Components of the computing device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor and capable of performing various processes according to programs stored in the memory 1120. In multiprocessor systems, multiple processing units execute computer-executable instructions in parallel to improve parallel processing capabilities of computing device 1100.

Computing device 1100 typically includes a plurality of computer storage medium. Such medium may be any available medium accessible by the computing device 1100, including, but not limited to, volatile and non-volatile medium, removable and non-removable medium. The memory 1120 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which may be capable of storing information and/or data (e.g., training data for training) and may be accessed within computing device 1100.

The computing device 1100 may further include additional removable/non-removable, volatile/non-volatile storage medium. Although not shown in FIG. 11, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1120 may include a computer program product 1125 having one or more program modules configured to perform various methods or actions of various implementations of the present disclosure.

The communication unit 1140 implements communications with other computing devices over a communications medium. Additionally, the functionality of components of the computing device 1100 may be implemented in a single computing cluster or multiple computing machines capable of communicating over a communication connection. Thus, the computing device 1100 may operate in a networked environment using logical connections with one or more other servers, network personal computers (PCs), or another network node.

The input device 1150 may be one or more input devices such as a mouse, a keyboard, a trackball, or the like. The output device 1160 may be one or more output devices, such as a display, a speaker, a printer, or the like. Computing device 1100 may also communicate with one or more external devices (not shown) as needed, external devices such as storage devices, display devices, etc., communicate with one or more devices that enable a user to interact with computing device 1100, or communicate with any device (e.g., network card, modem, etc.) that enables computing device 1100 to communicate with one or more other computing devices. Such communication may be performed via an input/output (I/O) interface (not shown).

According to example implementations of the present disclosure, a computer-readable storage medium is provided, where the computer-readable storage medium has computer-executable instructions stored thereon which, when executed by a processor, implement the method described above. According to example implementations of the present disclosure, a computer program product is further provided, the computer program product being tangibly stored on a non-transitory computer-readable medium and including computer-executable instructions which, when executed by a processor, implement the method described above. According to example implementations of the present disclosure, a computer program product is provided, where the computer program product has a computer program stored thereon which, when executed by a processor, implements the method described above.

Aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowcharts and/or block diagrams. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowcharts and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowcharts or block diagrams may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or acts, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for generating a video, comprising:
obtaining a plurality of evaluation indicators of a plurality of video frames in a first video, respectively;
dividing the plurality of video frames into at least one group of consecutive video frames based on the plurality of evaluation indicators, respective evaluation indicators of respective video frames in the at least one group of consecutive video frames meeting a predetermined condition;
determining, for a first group of consecutive video frames in the at least one group of consecutive video frames, a first time period associated with the first group of consecutive video frames; and
generating a second video by using a first video segment in the first time period in the first video.

2. The method of claim 1, wherein the plurality of video frames is obtained by: determining the plurality of video frames from a first plurality of video frames in the first video according to a predetermined interval, a number of the plurality of video frames being less than or equal to a number of the first plurality of video frames.

3. The method of claim 1, wherein the first video comprises at least any of:
a single video; or
a plurality of videos connected in a predetermined time order.

4. The method of claim 1, wherein obtaining the plurality of evaluation indicators respectively comprises: with respect to a target video frame in the plurality of video frames,
determining an evaluation indicator corresponding to at least one evaluation indicator dimension, the at least one evaluation indicator dimension comprising at least any of: an image dimension of the target video frame, or a scene dimension of the target video frame; and
determining a target evaluation indicator for the target video frame among the plurality of evaluation indicators based on the evaluation indicator corresponding to the at least one evaluation indicator dimension.

5. The method of claim 4, wherein:
an evaluation indicator for the image dimension indicates at least any of: a clarity, a contrast, or brightness of an image of the target video frame; and
an evaluation indicator for the scene dimension indicates a matching degree between a target scene of the target video frame and scene information.

6. The method of claim 4, wherein determining the target evaluation indicator for the target video frame comprises:
determining a scene type of the first video;
determining at least one evaluation indicator weight for the at least one evaluation indicator dimension based on the scene type; and
determining the target evaluation indicator based on the at least one evaluation indicator weight and the at least one evaluation indicator dimension.

7. The method of claim 6, wherein determining at least one evaluation indicator weight comprises at least any of:
in response to determining that the scene type indicates a static scene, increasing an evaluation indicator weight for the image dimension, and decreasing an evaluation indicator weight for the scene dimension; or
in response to determining that the scene type indicates a dynamic scene, increasing an evaluation indicator weight for the scene dimension, and decreasing an evaluation indicator weight for the image dimension.

8. The method of claim 1, further comprising:
determining, for a second group of consecutive video frames in the plurality of video frames, a second time period associated with the second group of consecutive video frames in response to determining that respective evaluation indicators of respective video frames in the second group of consecutive video frames do not meet the predetermined condition; and
indicating the first time period by using a first format and indicating the second time period by using a second format.

9. The method of claim 8, further comprising:
presenting an adjustment control for adjusting the first time period; and
in response to receiving an interaction operation for the adjustment control, adjusting the first time period based on the interaction operation.

10. The method of claim 9, further comprising: generating the second video by using a video segment within the adjusted first time period.

11. The method of claim 1, wherein generating the second video further comprises:
determining, for a third group of consecutive video frames in the plurality of video frames, a third time period associated with the third group of consecutive video frames in response to determining that respective evaluation indicators of respective video frames in the third group of consecutive video frames meet the predetermined condition; and
generating the second video by using the first video segment and a third video segment in the third time period.

12. The method of claim 11, wherein generating the second video by using the first video segment and the third video segment comprises:
generating a transition video segment between the first video segment and the third video segment based on the first video segment and the third video segment; and
generating the second video based on the first video segment, the third video segment, and the transition video segment.

13. An electronic device, comprising:
at least one processing unit; and
at least one memory coupled to the at least one processing unit and storing instructions for execution by the at least one processing unit, the instructions, when executed by the at least one processing unit, cause the electronic device to perform acts comprising:
obtaining a plurality of evaluation indicators of a plurality of video frames in a first video, respectively;
dividing the plurality of video frames into at least one group of consecutive video frames based on the plurality of evaluation indicators, respective evaluation indicators of respective video frames in the at least one group of consecutive video frames meeting a predetermined condition;
determining, for a first group of consecutive video frames in the at least one group of consecutive video frames, a first time period associated with the first group of consecutive video frames; and
generating a second video by using a first video segment in the first time period in the first video.

14. The electronic device of claim 13, wherein the plurality of video frames is obtained by: determining the plurality of video frames from a first plurality of video frames in the first video according to a predetermined interval, a number of the plurality of video frames being less than or equal to a number of the first plurality of video frames.

15. The electronic device of claim 13, wherein the first video comprises at least any of:
a single video; or
a plurality of videos connected in a predetermined time order.

16. The electronic device of claim 13, wherein obtaining the plurality of evaluation indicators respectively comprises: with respect to a target video frame in the plurality of video frames,
determining an evaluation indicator corresponding to at least one evaluation indicator dimension, the at least one evaluation indicator dimension comprising at least any of: an image dimension of the target video frame, or a scene dimension of the target video frame; and
determining a target evaluation indicator for the target video frame among the plurality of evaluation indicators based on the evaluation indicator corresponding to the at least one evaluation indicator dimension.

17. The electronic device of claim 16, wherein:
an evaluation indicator for the image dimension indicates at least any of: a clarity, a contrast, or brightness of an image of the target video frame; and
an evaluation indicator for the scene dimension indicates a matching degree between a target scene of the target video frame and scene information.

18. The electronic device of claim 16, wherein determining the target evaluation indicator for the target video frame comprises:
determining a scene type of the first video;
determining at least one evaluation indicator weight for the at least one evaluation indicator dimension based on the scene type; and
determining the target evaluation indicator based on the at least one evaluation indicator weight and the at least one evaluation indicator dimension.

19. The electronic device of claim 18, wherein determining at least one evaluation indicator weight comprises at least any of:
in response to determining that the scene type indicates a static scene, increasing an evaluation indicator weight for the image dimension, and decreasing an evaluation indicator weight for the scene dimension; or
in response to determining that the scene type indicates a dynamic scene, increasing an evaluation indicator weight for the scene dimension, and decreasing an evaluation indicator weight for the image dimension.

20. A non-transitory computer-readable storage medium having a computer program stored thereon which, when executed by a processor, causes the processor to implement acts comprising:
obtaining a plurality of evaluation indicators of a plurality of video frames in a first video, respectively;
dividing the plurality of video frames into at least one group of consecutive video frames based on the plurality of evaluation indicators, respective evaluation indicators of respective video frames in the at least one group of consecutive video frames meeting a predetermined condition;
determining, for a first group of consecutive video frames in the at least one group of consecutive video frames, a first time period associated with the first group of consecutive video frames; and
generating a second video by using a first video segment in the first time period in the first video.
